(19) United States
(12) Patent Application Publication
(10) Pub. No.: US 2004/0214908 A1
(43) Pub. Date: Oct. 28, 2004

(54) Phthalate polyester polyl-based and high dimensionally stable all water-blown spray polyurethane foam derived therefrom

(76) Inventor: Warren A. Kaplan, Grayslake, IL (US)

Correspondence Address: MCANDREWS HELD & MALLOY, LTD, 500 WEST MADISON STREET, SUITE 3400, CHICAGO, IL, 60661

(21) Appl. No.: 10/847,134

(22) Filed: May 17, 2004

Related U.S. Application Data
(62) Division of application No. 10/173,070, filed on Jun. 17, 2002.
(60) Provisional application No. 60/298,559, filed on Jun. 15, 2001.

(51) Int. Cl. C08J 9/00

(52) U.S. Cl. 521/50

(57) ABSTRACT

The invention relates to methods and compositions for preparing all water blown spray polyurethane foams by reacting a polyisocyanate with a polyol blend. The polyol methods and compositions of the invention comprises a polyol component, water, a cell opening agent, and a diluent. Polyurethane foams prepared according to the invention meet the physical and processing requirements stipulated by the industry.

This application claims priority from U.S. application Ser. No. 10/173,070, filed Jun. 17, 2002, which claims priority to U.S. Provisional Application Serial No. 60/298,559, filed Jun. 15, 2001.

### BACKGROUND OF THE INVENTION

1. Field of the Invention

This invention relates to phthalate polyester-based compositions and high dimensional stability all water-blown spray polyurethane foams derived from such compositions. More Particularly, it relates to phthalate polyester-based compositions comprising a polyester polyol, a cell opening agent, a catalyst, and water. The invention also relates to methods for preparing the phthalate polyester-based compositions and methods of producing spray foams therefrom. Further, the invention relates to the use of such foams as insulation materials, especially roof insulation materials.

2. Description of the Related Art

In the manufacture of refrigeration cabinets, picnic coolers, doors, and other insulated containers, polyurethane foam is poured in place between two substrates defining a cavity. In the production of roofing insulation, polyurethane foam is typically sprayed into place.

There are several desirable criteria that polyurethane foam should possess. One requirement is that the polyurethane foam should flow well and/or spread evenly on a surface so that the entire cavity is filled with the foam or the entire surface area is evenly coated with the foam. If the foam prematurely gels, voids will form behind the prematurely gelled foam where the foaming mass could not reach or as in a spray foam application, the foam will not produce uniform coverage over a substrate. A second requirement is to use the least amount of raw foaming material to fill a particular cavity or cover a surface to save on raw material costs. To adequately fill all portions of the cavity and prevent the presence of voids, it is often necessary to over pack the cavity or over cover the surface. The less overpacking that is necessary to completely fill the mold, however, the greater the savings in raw material costs. Thus, it is desired to form a polyurethane-filled container having the lowest density possible. A third criteria is that an alternative blowing agent to ozone depleting CFCs and HCFCs is needed. Several fully halogenated hydrocarbons (chlorofluorocarbons, commonly referred to as CFC's) normally used as blowing agents for the preparation of rigid foams are believed to cause environmental problems. For instance, CFC-11 (trichlorofluoromethane) and CFC-12 (dichlorodifluoromethane) have been implicated in the deterioration of the stratospheric ozone layer and are no longer used in the preparation of polyurethanes. Many partly halogenated hydrocarbons currently in use will no longer be available for polyurethane foam use beyond 2003.

Water is clearly viewed as the safest, most economically and ecologically attractive alternative blowing agent for the spray foam industry and many polyurethane foam manufacturers are now turning to water as the sole source of blowing agent instead of CFCs or HCFCs. However, to this point no water blown spray foam has proven practical or effective due to a variety of significant limitations. For example, in the field of cooling containers where the foam is poured in place, water-blown rigid polyurethane foams present a unique problem. Rigid polyurethane foams blown with water tend to be closed-celled foams which shrink and pucker over a period of time after foaming and during cure. This is partly due to the migration of carbon dioxide gas, produced by the reaction of water with polyisocyanate, out of the closed cells and leaving behind a vacuum which then tightens and shrinks the foamed mass over time. Foam that shrinks in foamed-in-place applications will either pull away from a substrate, or continue to adhere to the inner surface of the substrates causing waviness and surface deformities on the substrate. The problem of foam shrinkage in CFC-blown and HCFC-blown foams has not been as acute since CFC gases tend to migrate out of the closed cells very slowly over a period of months or years, if at all, resulting in a minimized pressure gradient within the foam. The problem of foam shrinkage or dimensional stability is more severe in applications such as picnic coolers where the coolers are often subject to wide temperature variations, from indoor 70-80° F. temperatures to beach temperatures in direct sun which may climb to 110- 120° F., causing the gas in the cells to further expand and diffuse out.

In general, water-blown foams have suffered from poor dimensional stability, narrow processing window, high reaction exotherm, poor inter-laminar and substrate adhesion, and an inability to be processed on conventional spray foam equipment. The difficulty in processing on routine equipment has been the result of higher formulation viscosity; due to the absence of HCFC-141b blowing agent, no thinning of the resin occurs as is normally the case when such a blowing agent is present. Additionally, the requirement for increased isocyanate usage (due to the presence of significant water levels) has precluded use on conventional equipment which frequently require processing at 1:1 isocyanate/resin volume ratios. Poor adhesion characteristics are the result of increased foam friability associated with poor mixing (due to the higher resin viscosity) as well as extensive use of high functional polyether and/or Mannich-type polyols. These high functional polyols are normally required in order to provide the foamed polymer with adequate crosslink density to resist shrinkage. The high reaction exotherm, a direct result of the water-isocyanate reaction and the absence of cooling from a physical blowing agent such as HCFC-141b, contributes to foam cracking and surface blisters. The extensive heat also makes it difficult to control the reaction profile thereby limiting the range of environmental conditions under which the spray foam can be applied.

It is, therefore, desirable to produce a foam having a lower density yet which fully fills the cavity or spreads on a surface and is dimensionally stable in order to lower raw material costs. Lowering the density, however, especially in water-blown foam already having a tendency to shrink has the attendant disadvantage of further exacerbating the dimensional instability of the foam. Examples of open celled foams have been described in U.S. Pat. Nos. 5,214,076; 5,219,893; 5,250,579; 5,262,447; 5,318,997; 5,346,928; 5,350,777; 6,066,681; and 6,211,257, each of which is incorporated herein in its entirety.

### SUMMARY OF TEE INVENTION

The invention avoids many or all of the limitations which have excluded water-blown spray foams from commercial viability. The invention provides a solution to the dimensional stability issue. By smoothly and homogeneously opening the cells of the sprayed foam, a rapid pressure equalization is permitted after carbon dioxide departure, thereby limiting or eliminating vacuum-induced shrinkage. Through incorporation of the unique cell opening technology of the invention formulation component modifications can readily be made without impacting foam dimensional stability. In particular, the invention makes it possible to adjust the polyol composition to lessen polymer reliance on high functional polyether or Mannich-type polyols. This results in lower formulation viscosity and improved adhesion characteristics. In one aspect of the invention, a significant proportion of low functional, i.e., 1-2 functional groups, polyester polyol is incorporated into the polyol formulation.

The invention also relies on the use of diluents in the formulation. These diluents (which are typically plasticizers) perform several functions including viscosity reduction, enhanced flammability performance, reduction in reaction exotherm, and the ability to process the resin on conventional spray foam equipment. In particular, the use of diluents as provided herein allows the foam to be processed at 1:1 A/B volume -ratio without adversely affecting the qualitative or physical properties of the polymer, wherein the “A-side” means materials comprising an isocyanate and/or isocyanurate and the “B-side” means materials comprising a polyol, as those terms are used by those skilled in the art.

In summary, the invention provides spray foam technology and spray foams that meet the physical and processing requirements stipulated by the industry; the invention provides the first and only commercially viable all water-blown spray foam available. Thus, in one aspect, the invention provides spray foams that are the product of a reaction mixture comprising a polyol blend and a polymeric isocyanate, preferably at a blend/isocyanate volume ratio of about 1:1. These blends comprise a polyol formulation, diluent, cell opening agent, and blowing agent. The blends optionally include other components as necessary to adjust, e.g., the viscosity and stability of the blend. The polyol formulation, as discussed below comprises any of a variety of polyols, i.e., polyester polyol, polyether polyol, and/or Mannich-type polyol

The invention provides dimensionally stable, low density, all water blown polyurethane foams that are prepared predominantly with low functional polyester polyols. These foams have an open cell content sufficient to prevent shrinkage of the foam. Further, the inventive foams are of a strength sufficient to prevent shrinkage of the foam.

Accordingly, in one aspect of the invention, there is provided a method for preparing a polymeric foam comprising urethane units and having an open-cell content sufficient to resist shrinkage. This method comprisesreacting an aromatic polymeric isocyanate with a dispersed polyol blend, where the polyol blend comprises:

(a) from about 20%, preferably 25%, to about 90% based on the weight of the polyol blend of a polyol formulation;

(b) a blowing agent;

(c) a cell opening agent which is a divalent metal salt of a fatty acid; and

(d) from about 0.05 to about 50 % by weight of the polyol blend of a diluent.

Another aspect the invention provides polyol blends, i.e., a polyol resins, suitable for preparing a polymeric foam comprising urethane units and having an open-cell content sufficient to resist shrinkage. These blends comprise:

(a) a polyol formulation comprising from about 25-90% by weight of the blend of a polyester polyol, a polyether polyol and/or a Mannich-type polyol;

(b) a blowing agent;

(c) a cell opening agent which is a divalent metal salt of a fatty acid; and

(d) from about 0.05% to about 50% by weight of the blend of a diluent.

In one aspect, the the polyol blends are dispersed polyol blends.

The inventive foams are-produced using cell opening agents having melting points or softening points between about 100 and 180 ° C. When formulated according to the invention, these cell opening agents form part of a dispersed polyol blend having a dispersion droplet or particle size of less than about 50μ. Without being bound by a particular theory, it is believed that during the polymerization reaction, the dispersion containing the cell opener breaks down releasing the cell opener thus allowing controlled cell opening. Without being bound by a particular theory, it is believed that cell opening takes place immediately prior to polymer gelation.

The resulting low density, water blown foam is primarily an open celled foam and exhibits dimensional stability in both the sprayed free rise state as well as within a packed cavity. By “primarily open celled” is meant a foam that has a sufficient amount or percentage of open cells to resist shrinkage.

Thus, the invention encompasses methods and compositions for preparing polyurethane foams having strength and an open-cell content sufficient to prevent or resist shrinkage comprising reacting an aromatic polymeric isocyanate with a dispersed polyol blend. The dispersed polyol blend of the invention comprises a polyol formulation, a blowing agent, a cell opening agent; and a diluent.

The polyol formulation of the invention may optionally contain an acid. It has been unexpectedly discovered that the addition of an acid to a combination of a polyol, a blowing agent such as water, and a specific cell opening agent provides a dispersed polyol blend that has surprising stability. The dispersed polyol blends, when reacted with aromatic isocyanates, form open-celled, spray and pour-in-place urethane foams having excellent dimensional stability at low densities.

The invention also provides polyol blends comprising a polyol formulation, preferably containing high levels, i.e., up to about 100% by weight of the formulation, of a polyester polyol, together with a blowing agent and a cell opening agent. optionally, the polyol blends of the invention may comprise an emulsifier.

### DETAILED DESCRIPTION OF THE INVENTION

In this document, all temperatures are stated in degrees Celsius unless otherwise indicated. All amounts, ratios, concentrations, proportions and the like are stated in weight units, unless otherwise stated, except for ratios of solvents, which are in volume units. Percentages are by weight unless otherwise indicated.

By OH value is meant hydroxyl value, a quantitative measure of the concentration of hydroxyl groups, usually stated as mg KOH/g, i.e., the number of milligrams of potassium hydroxide equivalent to the hydroxyl groups in 1 g of substance.

By NCO/OH index is meant the molar ratio, multiplied by 100, of isocyanate groups to hydroxyl groups (including those contributed by water) in the reaction between the polyol blend and the polyisocyanate.

By functionality is meant the number of reactive groups, e.g., hydroxyl groups, in a chemical molecule.

By uniform open cell content is meant a polyurethane foam having an average open cell content that does not vary substantially between two or more samples removed from the same foam material and separated in the foam material by a distance of at least about 2 cm.

The polyol blends of the invention are preferably “dispersed polyol blends.” By the term “dispersed polyol blend” is meant a polyol blend or polyol resin, i.e., a mixture comprising a polyol formulation, cell opening agent, diluent and blowing agent, together with any optional components, where the cell opening agent, preferably as particles, and more preferably as particles having a mean diameter of less than about 50μ, is stably suspended in the polyol blend. Such a dispersion is stable for a period of time sufficient to allow reaction with the polyisocyanate to form an open-celled foam having an open-cell content sufficient to prevent or resist shrinkage. Preferably, the dispersed polyol blends are stable at a temperature of about 25 ° C. for at least about 1 week, more preferably, the blends are stable at 252° C. for at least about 3 months.

By softening point as used herein is meant a temperature at which a material becomes more liquid, less rigid, softer, or more elastic; i.e., a temperature at or above its glass transition temperature.

As used herein, resistance to shrinkage means less than about 5% shrinkage of a polyurethane foam material.

The polyol blends of the invention preferably have particles having mean diameters of less than about 50μ, more preferably less than about 25μ, even more preferably less than about 10μ, and most preferably less than about 1μ. Smaller particles are believed to result in improved stability of the polyol blends which in turn results in improved uniformity of the open celled content of the final polyurethane foams.

The invention provides polyurethane foams suitable for use as insulating materials disposed on or between a variety of substrates. Suitable substrate materials comprise metal such as aluminum or sheet metal; wood, including composite wood, acrylonitrile-butadiene-styrene (ABS) triblock of rubber, optionally modified with styrene-butadiene diblock, styrene-ethylene/butylene-styrene triblock, optionally functionalized with maleic anhydride and/or maleic acid; polyethylene terephthalate, polycarbonate, polyacetals, rubber modified high impact polystyrene (HIPS), blends of HIPS with polyphenylene oxide; copolymers of ethylene and vinyl acetate, ethylene and acrylic acid, ethylene and vinyl alcohol; homopolymers or copolymers of ethylene and propylene such as polypropylene, high density polyethylene, high molecular weight high density polyethylene, polyvinyl chloride, nylon 66, or amorphous thermoplastic polyesters, fiberglass or fiberglass composites; roof decking materials such as gypsum board, Dens-Deck, Iso-board, Cementitious Wood Fiber (Tectum Deck), Light Weight concrete, Modified Bitumen, and a variety of rubber based membranes.

The foams of the invention have in-place densities of from about 2 to 5.0 and, in one embodiment, the foams of the invention have in-place densities of from about 2.3 to 3.5, lbs./ft³ (pcf). The sprayed foams of the invention have sprayed in-place densities of from about 2.0 to 3.5 and, preferably, from about 2.3 to 3.3, pcf.

As explained in more detail below, the foams of the invention may be water blown foams. The water blown foams according to the invention have K-factors of at least about 0.16 to 0.24.

The polyurethane foam of the invention comprises the product of the reaction of the aromatic polyisocyanate with at least one polyol component in a polyol blend. The polyurethane foam is rigid, meaning that the ratio of tensile strength to compressive strength is high, on the order of 0.5 to 1 or greater, and has less than 10 percent elongation.

The blends disclosed herein are generally free of CFC and/or hydrocarbon blowing agents and are highly suited for use in spray foam applications, i.e., insulative roof spray foams.

Although not critical to the invention, the blends of the invention may optionally contain from about 0.01 -50.0 percent by weight of a cross linking agent. Suitable cross linking agents are, for example, higher functionality alcohols such as triols or pentaerythritol.

In a preferred aspect, the invention provides polyol blends suitable for preparing a urethane foam, comprising:

(a) from about 28% to about 85%, more preferably 80%, by weight, based on the weight of the composition, of a polyol formulation;

(b) from about 0.05% to about 3, preferably 2.0%, by weight, based on the weight of the composition, of a cell opening agent;

(c) from about 3.5%, preferably about 5%, to about 50, preferably about 45%, by weight, based on the weight of the composition, of a diluent; and

(d) from about 0.5% to about 5% by weight, based on the weight of the composition, of water.

More preferred polyols formulations of the invention comprise from about 1% to about 100% by weight of a polyester polyol or mixtures of such polyols. More preferably, the polyol formulation or mixtures thereof comprise polyester polyols having an OH value of from about 150 to 350 and a molecular weight of from about 350 to 700.

Even more preferred polyol formulations comprise from about 30-48% of polyester polyol by weight of the polyol blend, and most preferably from about 30-45% of polyester polyol by weight of the polyol blend.

The blends of the invention can further comprise:

(e) from about 0.25% to about 5% by weight, based on the weight of the composition, of a urethane catalyst; and/or

(f) from about 0% to about 1% by weight, based on the weight of the composition, of an acid; and/or

(g) from about 0% to about 3% by weight, based on the weight of the composition, of a surfactant.

In a preferred embodiment, the polyol formulation comprises from about 1% to 100%, more preferably about 75-100%, by weight, based on the weight of the polyol formulation, of a diethylene glycol phthalate polyester polyol having an OH value of from about 150 to 350 and comprising

(a) the reaction product of mixture comprising a phthalic acid compound and a low molecular weight aliphatic diol and

(b) an optional nonionic surfactant, and

where the diethylene glycol phthalate polyester polyol has a molecular weight of from about 350 to 700.

In a particularly preferred embodiment, the polyol blend comprises from about 50-85% by weight of a polyol formulation comprising a modified diethylene glycol phthalate polyester polyol having an OH value of about 290-325, an Mannich type polyol having an OH value of 415-435, and diethylene glycol.

In another particularly preferred embodiment, the polyol blend comprises from about 50-85% by weight of a polyol formulation comprising a modified diethylene glycol phthalate polyester polyol having an OH value of about 23-350, an Mannich type polyol having an OH value of 415-435, and diethylene glycol.

In another particularly preferred embodiment, the polyol blend of the invention comprises about

(a) 30-35% by weight of a modified diethylene glycol phthalate polyester polyol having an OH value of about 290-325 or a modified diethylene glycol phthalate polyester polyol having an OH value of about 230-250;

(b) 20-30% by weight of an Mannich type polyol having an OH value of 415-435;

(c) 5.5-9% by weight of diethylene glycol

(d) 1-3% by weight of water;

(e) 0.1-1% by weight of the cell opener; and

(f) about 18-34% by weight of the diluent.

In another preferred embodiment, the polyol blend comprises, based on the weight of the blend,

about 30-35% by weight of the modified diethylene glycol phthalate polyester polyol having an OH value of about 290-325 or the modified diethylene glycol phthalate polyester polyol having an OH value of about 230-250,

from about 20-30 by weight of the Mannich type polyol having an OH value of 415-435,

from about 6-8% by weight of diethylene glycol,

from about 1-3% by weight of water,

from about 0.15-2.5% by weight of the cell opener, and

from about 20-34% by weight of the diluent.

In one aspect, the invention relates to a urethane foam made from a reaction mixture comprising (a) a polyol blend of the invention, and (b) an isocyanate, a polyisocyanate, or a mixture thereof. In this embodiment, the isocyanate preferably is 2,4- and/or 2,4/2,6-toluene diisocyanate, diphenyl methane 4,4′-diisocyanate, hexamethylene diisocyanate, isophorone diisocyanate, or a mixture thereof. Also in this embodiment, the polyisocyanate is alternatively a polyphenyl polymethylene polyisocyanate.

The invention further relates to a method for preparing polyol compositions which is suitable for preparing a urethane foam. This method comprises combining:

(a) from about 38% to about 90% by weight, based on the weight of the composition, of a polyol formulation;

(b) from about 0.05% to about 2.0% by weight, based on the weight of the composition, of a cell opening agent;

(c) from about 5% to about 45% by weight, based on the weight of the composition, of a diluent; and

(d) from about 0.5% to about 5% by weight, based on the weight of the composition, of water.

The methods of the invention can further include adding the following optional components:

(e) from about 0.25% to about 5% by weight, based on the weight of the composition, of a urethane catalyst; and/or

(f) from about 0% to about 1% by weight, based on the weight of the composition, of an acid; and/or

(g) from about 0% to about 3% by weight, based on the weight of the composition, of a surfactant.

In anther embodiment, the invention provides a polyurethane foam comprising from about 0.01 to 1% by weight of a cell opening agent which is a divalent metal salt of a fatty acid, where the foam has an open-cell content sufficient to resist shrinkage and exhibits less than about 5% shrinkage when stored at about 158 ° F. and about 100% relative humidity for about 28 days. These foams comprise the reaction product of an aromatic polymeric isocyanate with a polyol blend of the invention.

Preferably, the polyurethane foam exhibits less than about 3% shrinkage when stored at −20° F. for 28 days.

In yet another embodiment, the invention relates to a method for preparing a urethane foam comprising reacting the polyol composition with an isocyanate, a polyisocyanate, or a mixture thereof, to produce the foam. In accordance with this embodiment, the NCO/OH index of the foam is 85-125. The foam produced in accordance with the embodiments disclosed herein is pourable, and/or is sprayable. Accordingly, the invention also relates to methods of applying spray foams, which are derived from the blends described herein, to various substrates, particularly roofs.

### Polyols

The polyols suitable for use in the invention are polyester polyols, polyether polyols and Mannich-type polyols. Preferred polyol blends are those that comprise a polyester polyol. In these preferred blends, the polyester polyol can be up to about 100% of the polyol formulation. In other preferred polyol blends, the polyol formulation is a mixture of polyols, e.g., (a) polyester polyol and polyether polyol, (b) polyester polyol and polyether polyol, (c) polyether polyol and Mannich-type polyol, or (d) polyether polyol, polyester polyol, and Mannich-type polyol. Thus, the polyol formulation may be up to about 100% by weight of polyether polyol, i.e., it may be polyester polyol free, or may contain a mixture of polyether and polyester polyols .

Starting polyol components suitable for use in the polyol blends or mixtures according to the invention include polyesters containing at least two hydroxyl groups, as a rule having a molecular weight of from 300 to 10,000, in particular polyesters containing from 2 to 8 hydroxyl groups, and, in some embodiments of the invention, having a molecular weight of from 350 to 700, in other embodiments having a molecular weight of from 350 to 600, wherein the acid component of these polyesters comprise at least 50% by weight in one embodiment, and at least 70% by weight in another embodiment, of phthalic acid residues.

These polyesters containing hydroxyl groups include for example, reaction products of polyhydric, such as dihydric and trihydric, alcohols with phthalic acids and other polybasic, such as dibasic, carboxylic acids. Instead of using the free phthalic acids or polycarboxylic acids, the corresponding acid anhydrides or corresponding acid esters of lower alcohols or mixtures thereof may be used for preparing the polyesters. Orthophthalic acids, isophthalic acids and/or terephthalic acids may be used as the phthalic acid. The optional polybasic-carboxylic acids may be aliphatic, cycloaliphatic, aromatic and/or heterocyclic and may be substituted, for example, with halogen atoms and/or may be unsaturated. The following are mentioned as examples; succinic acid, adipic acid, suberic acid, azelaic acid, sebacic-acid, trimellitic acid, trimellitic anhydride, tetrahydrophthalic acid anhydride, hexahydrophthalic acid anhydride, endomethylene tetrahydro phthalic acid anhydride, glutaric acid anhydride, maleic acid, maleic acid anhydride, fumaric acid, dimeric and trimeric fatty acids, such as oleic acid, optionally mixed with monomeric fatty acids. Suitable polyhydric alcohols include, for example, ethylene glycol, propylene glycol-(1,2) and -(1,3), diol-(1,8), neopentyl glycol, cyclohexane dimethanol (1,4-bis-hydroxymethylcyclohexane), 2-methyl-1,3-propane diol, glycerol, trimethylolpropane, hexanetriol-(1,2,6) butane triol-(1,2,4), trimethylolethane, pentaerythritol, quinitol, mannitol and sorbitol, methylglycoside, also diethylene glycol, triethylene glycol, tetrathylene glycol, polyethylene glycols, dibutylene glycol, and polybutylene glycols. The polyesters may also contain carboxyl end groups. Polyesters of lactones, such as ε-caprolactone, or hydroxycarboxylic acids, such as δ-hydroxycaproic acid, may also be used.

In one embodiment, polyester polyols for use in the invention comprise the reaction products of (a) phthalic acid compounds, (b) low molecular weight aliphatic diol compounds, (c) and nonionic surfactant compounds. Such polyester polyols are described in U.S. Pat. Nos. 4,644,047 and 4,644,048, each of which is incorporated herein in its entirety.

Suitable polyols for the invention also include Mannich-type polyols. Mannich-type polyols are prepared by reacting, for example, nonylphenol, formaldehyde, and mono or dialkanolamines or mixtures thereof. This intermediate is then typically reacted with alkylene oxide to produce the final “Mannich Polyol. The preparation of Mannich-types polyols is also described in U.S. Pat. Nos. 3,297,597; 4,137,265; 4,383,102; 4,247,655; 4,654,376, each of which is incorporated herein in its entirety.

According to the invention, polyethers containing at least one, generally from 2 to 8, and, in one embodiment of the invention, 3 to 6 hydroxyl groups and having a molecular weight of from 100 to 10,000 may be used in the polyol blend. These are prepared, for example, by the polymerization of epoxides, such as ethylene oxide, propylene oxide, butylene oxide, tetrahydrofuran, styrene oxide, or epichlorohydrin, either on its own for example in the presence of BF₃, or by chemical addition of these epoxides, optionally as mixtures or successively, to starting components having reactive hydrogen atoms, such as alcohols or amines, for example water, ethylene glycol, propylene glycol-(1,3) or -(1,2), trimethylol propane, 4,4-dihydroxy diphenylpropane aniline, ammonia ethanolamine or ethylene diamine. Sucrose polyethers which have been described, for example in German Auslgeschrift Nos. 1,176,358 and 1,064,938 may also be used according to the invention.

Among the corresponding polythioethers which may also be used are the condensation products obtained from thiodiglycol on its own and/or with other glycols, dicarboxylic acids, formaldehyde, aminocarboxylic acids or aminoalcohols should be particularly mentioned. The products obtained are polythio mixed ethers, polythio ether esters or polythio ether ester amides, depending on the co-components.

Polyhydroxyl compounds already containing urethane or urea groups and modified or unmodified natural polyols, such as castor oil, carbohydrates or starch may also be used. Addition products of alkylene oxides and phenyl/formaldehyde resins or of alkylene oxides and urea/formaldehyde resins are also suitable according to the invention.

Representatives of these compounds which may be used according to the invention have been described, for example, in High Polymers, Volume XVI, “Polyurethanes, Chemistry and Technology”, by Saunders and Frisch, Interscience Publishers, New York; London, Volume I, 1962, pages 32-42 and pages 44 to 54 and Volume II, 1964, pages 5 and 6 and 198-199, and in Kunststoff-Handbuch, Volume VII, Vieweg-Hochtlen, Carl-Hanser-Verlag, Munich, 1966, for example, on pages 45 to 71.

In certain embodiments, the polyol formulation comprises a phthalate polyester-ether polyol. These polyester-ether polyols are the reaction product of a phthalate polyester polyol (“intermediate polyester polyol” and a polyhydridic polyol.

The intermediate phthalate polyester polyol is the reaction product of:

(1) about 2-60% by weight, based on the weight of the polyester polyol, of phthalic anhydride or phthalic acid; and

(2) about 40-98% by weight, based on the weight of the polyester polyol, of at least one polyol of the formula:

HO—R₁—OH

wherein R₁ represents:

(a) alkylene groups of about 2 to 10 carbon atoms; or

(b) —CH₂—R₂—CH₂—

where R₂ represents:

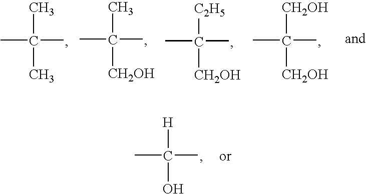

(c) a mixture thereof.

The R₁ alkylene group may be branched or straight chain, saturated or unsaturated, and when R₂ contains a hydroxyl moiety, such hydroxyl group may be optionally alkoxylated.

Preferably, the phthalate polyester polyol is of the general formula:

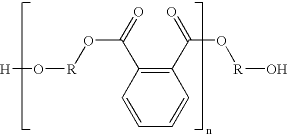

wherein R represents:

(a) alkylene groups of about 2 to 10 carbon atoms; or

(b) —CH₂—R₂-CH₂—

where R₂ represents:

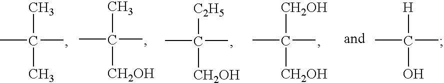

or

(c) a mixture thereof.

Suitable polyhydridic polyols include (i) alkoxylated glycerine, such as propoxylated glycerine, (ii) alkoxylated sucrose, and (iii) alkoxylated glycols, such as diethylene glycol, ethylene glycol, propylene glycol, butylene glycol, and the like, or mixtures of any of these polyhydric alcohols. Typical alkoxylating agents for any of these polyhydric alcohols are ethylene, propylene and/or butylene oxide.

In a preferred aspect, the polyester and polyhydric alcohol are combined together in the polyol blend and before reacting the blend with the isocyantate “A-side”. In these blends, the polyester polyol and polyhydric alcohols may be present at a variety of suitable ratios. Suitable ratios of polyester polyol to polyhydric alcohol are from about 25:1 to 1:1. More preferred ranges are from higher ratios of about 20:1 or 15:1 to lower ratios of about 1.5:1. Even more higher ratios are about 8:1. More preferred lower ratios are 3:1 or 2:1.

The polyester-ether polyols of the invention may be the reaction product of phthalic anhydride (PA), a polyhydroxyl compound, and an alkoxylating agent, e.g., propylene oxide, as shown below:

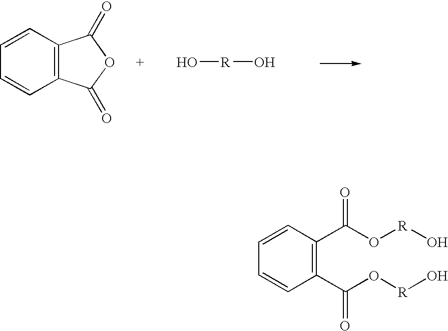

wherein R is branched or linear, saturated or unsaturated C₂₋₁₀ alkyl, cycloalkyl, alkenyl, alkynyl, aromatic, polyoxyethylenic, polyoxypropylenic; wherein R may contain pendant secondary functionality such as hydroxyl, aldehyde, ketone, ether, ester, amide, nitrile, amine, nitro, thiol, sulfonate, sulfate, and/or carboxylic groups. Where pendant secondary hydroxyl functionality is present, such hydroxyl groups may optionally be alkoxylated. In some embodiments of the invention, phthalic anhydride is reacted with a polyol, i.e., a diol such as diethylene glycol to form a polyester polyol.

Preferred polyester polyols may be made as follows

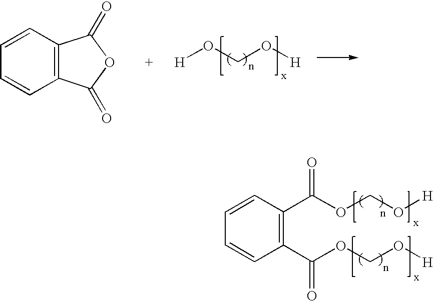

wherein n=2-10, x=1-500. In accordance with this embodiment, PA polyester polyol intermediates for use in the invention are derived from the condensation of phthalic anhydride and ethylene glycol, diethylene glycol, propylene glycol, dipropylene glycol, neopentyl glycol, 1,4-butanediol, 1,6-hexanediol, polyethylene glycol, polypropylene glycol triethylene glycol, and tetramethylene glycol and mixtures thereof.

Specific polyester polyols suitable for use in the compositions of the invention include for example phthalic acid diethylene glycol polyester polyols. Suitable phthalic acid diethylene glycol polyester polyols are commercially available from Stepan Company, Northfield, Illinois. Representative auxiliary polyols are StepanPol® PS-2002 (a phthalic anhydride diethylene glycol polyester polyol having an OHv of 195 and a functionality of 2), StepanPol® PS-3152 (a phthalic anhydride diethylene glycol polyester polyol having an OHv of 315 and a functionality of 2), StepanPol® PS-4002 (a phthalic anhydride diethylene glycol polyester polyol having an OHv of 400 and a functionality of 2), and StepanPol PS-2502A (an aromatic polyester polyol having an OHv of 245) and mixtures thereof. In the invention, by OH value (OHv) is meant hydroxyl value, a quantitative measure of the concentration of hydroxyl groups, usually stated as mg KOH/g, i.e., the number of milligrams of potassium hydroxide equivalent to the hydroxyl groups in 1 g of substance. By functionality is meant the number of reactive groups, e.g., hydroxyl groups, in a chemical molecule.

Other auxiliary polyester polyols, i.e. non-phthalic anhydride-based polyester polyols, include for example, polyester polyols derived from the condensation of caprolactone and a poly alcohol, and terate polyester polyols (e.g. Terate-203; a diethylene glycol terephthalate polyester polyol having an OHv of 315 and a functionality of 2.3; commercially available from Kosa). Specific auxiliary polyether polyols suitable for use in the methods and compositions of the invention include for example the condensation products of propylene glycol/propylene oxide, trimethylolpropane/ethylene oxide/propylene oxide, trimethylolpropane/propylene oxide, sucrose/propylene glycol/propylene oxide, alkylamine/propylene oxide, and glycerin/propylene oxide, and mixtures thereof.

### Polyisocyanate

The polyisocyanate starting components used according to the invention include aliphatic, cycloaliphatic, araliphatic, aromatic and heterocyclic polyisocyanates, such as those described, for example, by W. Siefken in Justus Liebigs Annalen der Chemie 562: 75-136. Examples include ethylene diisocyanate; tetramethylene-1,4-diisoyanate, hexamethylene-1,6-diisocyanate; dodecane-1,12-diisocyanate; cyclobutane-1,3-diisocyanate; cyclohexane-1,3- and 1,4-diisocyanate and mixtures of these isomers 1-isocyanato-3,3,5-trimethyl-5-isocyanatomethylcyclohexane (German Auslegeschrift No. 1,202,785, U.S. Pat. No. 3,401,190); hexahydrotolylene-2,4- and 2,6-diisocyanate and mixtures of these isomers; hexahydrophenylene-1,3- and/or -1,4-diisocyanate; perhydrodiphenylmethane-2,4′- and/or 4,4′-diisocyanate; phenylene-1,3- and -1,4-diisocyanate; tolylene-2,4- and -2,6-diisocyanate and mixtures of these isomers; diphenylmethane-2,4′- and/or -4,4′-diisocyanate; naphthylene-1,5-diisocyanate; triphenylmethane-4,4′,4″-triisocyanate; polyphenylpolymethylene polyisocyanate which may be obtained by aniline/formaldehyde condensation followed by phosgenation and which have been described, for example, in British Pat. Nos. 874,430 and 848,671; m- and p-isocyanatophenyl sulphonyl isocyanate according to U.S. Pat. No. 3,454,606; perchlorinated aryl polyisocyanate as described, for example, in U.S. Pat. No. 3,277,138; polyisocyanate; containing carbodiimide groups as described in U.S. Pat. No. 3,152,162; the diisocyanates described in U.S. Pat. No. 3,492,330; polyisocyanates containing allophanate groups as described, for example, in British Pat. No. 994,890, Belgian Pat. No. 761,626 and Published Dutch Patent application No. 7,102,524; polyisocyanates containing isocyanurate groups as described, for example, in U.S. Pat. No. 3,001,973, in German Pat. Nos. 1,022,789; 1,222,067 and 1,027,394 and in German Offenlegungsschriften Nos. 1,929,034 and 2,004,048; polyisocyanates containing urethane groups as described, for example, in Belgian Pat. No. 752,261 or in U.S. Pat. No. 3,394,164; polyisocyanates containing acrylated urea groups according to German Pat. No. 1,230,778; polyisocyanates containing biuret groups as described, for example, in U.S. Pat. Nos. 3,124,605 and 3,201,372; and in British Pat. No. 889,050; polyisocyanates prepared by telomerization reactions as described, for example in U.S. Pat. No. 3,654,016; polyisocyanates containing ester groups as mentioned, for example, in British Pat. Nos. 965,474 and 1,072,956, in U.S. Pat. No. 3,567,763 and in German Pat. No. 1,231,688; reaction product of the above-mentioned isocyanates with acetals according to German Pat. No. 1,072,385; and, polyisocyanates containing polymeric fatty acid groups as described in U.S. Pat. No. 3,455,883. Also suitable for use in the present invention are isocyanate terminated pre-polymers using hydroxy containing reactants of any of the foregoing.

The distillation residues obtained from the commercial production of isocyanates and which still contain isocyanate groups may also be used, optionally dissolved in one or more of the above-mentioned polyisocyanates. Mixtures of the above-mentioned polyisocyanates may also be used.

In some embodiments of the invention, the polyisocyanates which are readily available are used, for example, toluene-2,4- and -2,6-diisocyanate and mixtures of these isomers (“TDI”); polyphenyl polymethylene polyisocyanates which may be obtained by aniline/formaldehyde condensation followed by phosgenation crude MDI”); and, polyisocyanates containing carbodiimide groups, urethane groups, allophanate groups, isocyanurate groups, urea groups or biuret groups (“modified polyisocyanates”), and mixtures thereof.

In some embodiments of the invention, polyisocyanates are 2,4- and/or 2,4/2,6-toluene diisocyanate, diphenyl methane 4,4′-diisocyanate, hexamethylene diisocyanate, and isophorone diisocyanate, and mixtures thereof.

In one embodiment of the invention, the polyisocyanate is methylene bis(phenyl isocyanate).

Suitable polyisocyanurates useful in the invention also include, as is well known to those skilled in the art, the cyclotrimerization product of any of the aforementioned polyisocyanates.

In a typical rigid spray-in-place application the polyisocyanate mixture is reacted with a polyol blend at a ratio of 0.9-1.1:1 (v/v) ratio. The reaction can be achieved using a spray gun apparatus or other suitable mixing devices. Alternatively, the reaction can be achieved using a high pressure impingement machine provided with a nozzle capable of filling a void volume. As another alternative, the reaction may be achieved using a low pressure static mixing machine equipped with a nozzle to fill a void volume.

### Acid Component

Some embodiments of the polyol formulation used in the invention comprises a polyester polyol and an acid. The acid is used in an amount capable of maintaining the dispersed polyol blend as a dispersion for a period of time sufficient to allow for the production of a polyurethane foam and preferably a foam having a uniform open celled content. The foam is made by reacting the polyol blend with an aromatic polyisocyanate.

The amount of acid optionally present is generally up to about 5% by weight of the polyol blend. In one embodiment, the amount of the acid is from about 0.05 to 5% by weight of the polyol blend. In another embodiment, the amount of acid is from about 0.1 to 1%.

Suitable acids are generally Bronsted acids, i.e., substances that can donate protons. In one embodiment of the invention, the acids are organic acids. In another embodiment, the acids are various alkanoic or alkenoic acids of the formula RCO₂H, where R is hydrogen, a straight or branched chain alkyl group having from about 1 to 12 carbon atoms, or a straight or branched chain alkenyl group having from about 2 to 12 carbon atoms. Representative acids include, for example, formic, acetic, isobutryic, and 2-ethylhexanoic acids. In a preferred embodiment, the acid is 2-ethylhexanoic acid.

### Blowing Agent

According to the invention, the reaction of the dispersed polyol blend as set forth above with a polyisocyanate provides an open cell rigid polyurethane foam as desired. In a preferred embodiment of the invention, water is used as a primary blowing agent in the dispersed polyol blend. In this embodiment, the amount of water as a blowing agent is about 0.5-5%, and can be about 1-4%, and further can be 1.5-2.5%, based on the weight of the composition. When the amount of water is insufficient, a low density foam may not be produced.

Although the preparation of the foam is typcially carried out using a dispersed polyol blend having water as a blowing agent, in another embodiment, the blowing agent comprises a secondary blowing agent, either alone, or preferably in combination with the primary blowing agent, water. Suitable secondary blowing agents include both CFC and non-CFC blowing agents. Secondary blowing agents are typically liquids having low boiling points.

Suitable secondary blowing agents include, but are not limited to, halogenated hydrocarbons such as, for example, 2,2-dichloro-2-fluoroethane (HCFC-141b), water, and hydrocarbons such as pentane, hydrofluorocarbons (HFCs) and perfluorocarbons for example. Other suitable organic blowing agents include, for example, acetone, ethyl acetate, halogenated alkanes, such as methylene chloride, chloroform, ethylidene chloride, vinylidene chloride, and also butane, pentane, hexane, heptane or diethylether. The effect of a blowing agent may also be obtained by adding compounds which decompose at temperatures above room temperature to liberate gases, such as nitrogen, for example, azo compounds, such as azoisobutyric acid nitrile. Other examples of blowing agents and details about the use of blowing agents may be found in Kunststoff-Handbuch, Volume VII, published by Vieweg-Hochtlen, Carl-Hanser-Verlag, Munich, 1966, for example, on pages 108 and 109, 453 to 455 and 507-510.

Further examples of suitable optional blowing agents are described in U.S. Pat. Nos. 5,346,928, which is incorporated herein in its entirety.

### Cell Opening Agent

Cell opening agents suitable for use in the invention include known powdered divalent metal salts of long chain fatty acids having from about 1-22 carbon atoms. Examples of such agents are divalent metal salts of stearic or myristic acid, such as calcium stearate, magnesium stearate, strontium stearate, zinc stearate or calcium myristate, as disclosed in Japanese Patent Application Laid-open No. 61-153480. The cell opening agent is used in an amount of about 0.01-2.0% based on the weight of the composition. The cell opening agent is typically capable of forming a stable dispersion with the polyester polyol.

In preferred embodiments of the invention, cell opening agents having melting or softening points of from about 100 to 180° C. are used. In one embodiment, dispersed polyol blends comprise from about 0.05 to 1.5% cell opening agent based on the weight of the composition. In another embodiment, dispersed polyol blends comprise from about 0.1 to 0.8% cell opening agent based on the weight of the composition.

### Isocyanate Polymerization Catalyst

Compounds which readily initiate a polymerization reaction of the NCO-groups at temperatures as low as room temperature are used as the catalyst system for polymerization. Compounds of this type are described, for example, in French Pat. No. 1,441,565, Belgian Pat. Nos. 723,153 and 723,152 and German Pat. No. 1,112,285.

Such catalyst systems are, in particular, mononuclear or polynuclear Mannich bases of condensable phenols, oxo-compounds and secondary amines which are optionally substituted with alkyl groups, aryl groups or aralkyl groups, and, in one embodiment of the invention, those in which formaldehyde is used as the oxo-compound and dimethylamine as the secondary amine.

According to the invention, the catalysts that may be used as the catalyst for the polyurethane reaction include, for example, tertiary amines, such as triethylamine, tributylamine, N-methyl morpholine, N-ethyl-morpholine, N-cocomorpholine, N,N,N′, N′-tetramethylethylenediamine, 1,4-diaza-bicyclo-(2,2,2)-octane, N-methyl-N′-dimethyl aminoethyl-piperazine, N,N-dimethylbenzylamine, bis-(N,N-diethylaminoethyl)-adipate, N,N-diethylbenzylamine, pentamethyldiethylenetriamine, N,N-dimethylcyclohexylamine, N,N,N′,N′-tetramethyl-1,3-butane-diamine, N,N-dimethyl-.beta.-phenylethylamine, 1,2-dimethylimidazole and 2-methylimidazole and Curithane 52 (available from Air Products).

Tertiary amines containing isocyanate-reactive hydrogen atoms used as catalysts include, for example, triethanolamine, triisopropanolamine, N-methyl-diethanolamine, N-ethyl-diethanolamine, N,N-dimethylethanolamine and the reaction products thereof with alkylene oxides, such as propylene oxide and/or ethylene oxide.

Silaamines having carbon-silicon bonds as described, for example, in German Pat. No. 1,229,290 (corresponding to U.S. Pat. No. 3,620,984) may also be used as catalysts, for example, 2,2,4-trimethyl-2-silamorpholine and 1,3-diethylaminomethyl-tetramethyl-disiloxane.

The catalysts used may also be basic nitrogen compounds, such as tetralkylammonium hydroxides, alkali metal hydroxides, such as sodium hydroxide, alkali metal phenolates, such as sodium phenolate, or alkali metal alcoholates, such as sodium methylate. Hexahydrotriazines may also be used as catalysts. Typically, the amine catalyst is employed in excess of the required acid. However, any of the catalysts derived from amines may be used in the invention as the corresponding ammonium salts or quaternary ammonium salts. Thus, in the practice of the invention, catalysts derived from amines may be present in the polyol blends as their corresponding acid blocked form. Accordingly, in certain embodiments, such a catalyst and the requisite acid may be simultaneously added conveniently as the amine salt of the acid.

According to the invention, organic metal compounds, in particular organic tin compounds, may also be used as catalysts.

Suitable organic tin compounds are, in some embodiments of the invention, tin(II)-salts of carboxylic acids, such as tin(II)-acetate, tin(II)-octoate, tin(II)-ethylhexoate and tin(II)-laurate, and the tin(IV)-compounds, for example dibutyl tin oxide, dibutyl tin dichloride, dibutyl tin diacetate, dibutyl tin dilaurate, dibutyl tin maleate or dioctyl tin diacetate.

Suitable organo lead compounds for use as primary catalysts include lead naphthanate and lead octoate.

All of the above-mentioned catalysts may be used as mixtures.

Further representatives of catalysts which may be used according to the invention, as well as details on the mode of operation of the catalyst are described in Kunststoff-Handbuch, Volume III, published by Vieweg-Hochtlen, Carl-Hanser-Verlag, Munich, 1966, for example, on pages 96 to 102.

Other catalysts include N,N-dimethyl-cyclohexylamine, lead naphthanate, tin octanoate and tin dilaurate.

Still other catalysts suitable for use in the invention include amino acid salt catalysts, e.g., those derived from sarcosine. Suitable amino salts derived from sarcosine include various N-(2-hydroxy or 2-alkoxy-5-alkylphenyl)alkyl sarcosinates. The alkyl groups are independently C₁-C₁₈ alkyl groups and the alkoxy groups are C₁-C₆ alkoxy groups. Of course, each of the sarcosinate derivatives includes a suitable counterion, such as, for example, sodium, potassium, magnesium, lithium, etc. In one embodiment of the invention, the amino acid salt is sodium N-(2-hydroxy-5-nonylphenyl)methyl sarcosinate. Each of the amino acid derivatives may be prepared according to the procedures set forth in U.S. Pat. No. 3,903,018. Representative amino acid salt catalysts are, for example, sodium N-(2-hydroxy-5-methylphenyl)methyl sarcosinate; sodium N-(2-hydroxy-5-ethylphenyl)methyl sarcosinate; sodium N-(2-hydroxy-5-butylphenyl)methyl sarcosinate; sodium N-(2-hydroxy-5-heptylphenyl)methyl sarcosinate; sodium N-(2-hydroxy-5-nonylphenyl)methyl sarcosinate; sodium N-(2-hydroxy-5-dodecylphenyl)methyl sarcosinate; potassium N-(2-hydroxy-5-nonylphenyl)methyl sarcosinate; lithium N-(2-hydroxy-5-nonylphenyl)methyl sarcosinate; and mixtures thereof. Other suitable catalysts include, for example, the disodium salt of 2,6-bis-(N-carboxymethyl-N-methylaminomethyl)-p-ethylphenol and the disodium salt of 2,6-bis-(N-carboxymethyl-N-methlaminomethyl)-p-nonylphenol; and mixtures thereof.

The catalysts are generally used in a quantity of from about 0.001 to 10%, by weight, based on the quantity of the polyesters used according to this invention.

### Diluents

As used herein, the terms diluent or diluents include within their scope plasticizer materials. Diluents suitable for use in the invention include those described in U.S. Pat. Nos. 3,773,697, 5,929,153, 3,929,700 and 3,936,410, the disclosures of each of which are incorporated herein by reference in their entirety. Suitable diluents include

(a) phthalic plasticizers such as di-n-butyl phthalate, di-2-ethylhexyl phthalate, di-n-octyl phthalate, diisononyl phthalate, diisodecyl phthalate, diisooctyl phthalate, octyldecyl phthalate, butylbenzyl phthalate and di-2-ethylhexyl isophthalate, aliphatic ester plasticizers such as di-2-ethylhexyl adipate, di-n-decyl adipate, diisodecyl adipate, dibutyl sebacate and di-2-ethylhexyl sebacate, trimellitic plasticizers such as trioctyl trimellitate and tridecyl trimellitate, phosphoric ester plasticizers such as tributyl phosphate, tri-2-ethylhexyl phosphate, 2-ethylhexyldiphenyl phosphate and tricresyl phosphate, epoxy plasticizers such as epoxy soybean oil, polyester-based high-molecular plasticizers, and the like. Other diluents suitable for use in the invention include, for example,

(b) propylene carbonate,

(c) alkyl esters of monobasic acids where the alkyl group is straight or branched chain alkyl having from 1-20 carbon atoms, such as 2-ethylhexylbenzoate, methyl 2-ethylhexanoate and the like (hereinafter “monobasic esters”),

(d) dialkyl esters of dibasic acids where each alkyl group is independently a straight or branched chain alkyl having from 1-carbon atoms (hereinafter “dibasic esters”),

(e) diacid esters of α, ω-diols where the acid is a straight or branched chain alkanoic acid having from 1-6 carbon atoms and the diol is a straight of branched chain aliphatic diol (hereinafter “diol esters”,

(f) mono- and di(C₁-C₆)alkyl ethers of alkylene and polyalkylene glycols (hereinafter “glycol ethers”),

(g) nonyl phenols alkoxylated with from 1 to about 50 moles of an alkoxylating agent or mixture of alkoxylating agents having from 1-6 carbon atoms, preferably about 7-12 moles of an alkoxylating agent having from 2-4 carbon atoms (hereinafter “alkoxylated nonyl phenols”), e.g., Makon 10 (available from Stepan Company),

(h) tris-isopropylchlorophosphate, and

(i) mixtures of any of (a)-(h).

Representative glycol ethers include monomethyl diethylene glycol, monoethyl dipropylene glycol, and monomethyltripropylene glycol.

Suitable diesters of dibasic acids for use in the invention include, for example, dimethyl adipate, dialkyl adipate, dimethyl glutarate, dimethyl succinate, H₃CO(CO) (CH₂)ₙ(CO)OCH₃, wherein n is an integer between 1 and 10, and di(2-ethylhexyl) adipate. A preferred aspect of the invention employs mixture of dibasic esters. A particularly preferred mixture contains about 20% by weight of dimethyl succinate, 21% by weight of dimethyl adipate and about 59% by weight of dimethyl glutarate.

A representative diacid ester of an α, ω-diol is 2,2,4-trimethyl-1,3-pentanediol diisobutyrate.

Preferred diluents include propylene carbonate, a dibasic ester mixture, alkoxylated nonyl phenols, more preferably Makon 10, tris-isopropylchlorophosphate, and glycol ethers, more preferably monomethyl dipropylene glycol and monomethyl tripropylene glycol.

In preferred embodiments of the invention, the diluents are of low viscosity (less than approximately 50 centipoise at 25° C.) and act as plasticizers within the polymer.

### Surfactants and Additives

Surfactants suitable for use in the invention include non-ionic surfactants and amphoteric surfactants such as those disclosed in U.S. Pat. No. 6,017,860 the disclosure of which is incorporated herein by reference in its entirety. Suitable nonionic surfactants in accordance with the invention are also generally disclosed at column, 13 line 14 through column 16, line 6 of U.S. Pat. No. 3,929,678, the disclosure of which is incorporated herein by reference in its entirety. Generally, the nonionic surfactant is selected from the group comprising polyoxyethyleneated alkylphenols, polyoxyethyleneated straight chain alcohols, polyoxyethyleneated branched chain alcohols, polyoxyethyleneated polyoxypropylene glycols, polyoxyethyleneated mercaptans, fatty acid esters, glyceryl fatty acid esters, polyglyceryl fatty acid esters, propylene glycol esters, sorbitol esters, polyoxyethyleneated sorbitol esters, polyoxyethylene glycol esters, polyoxyethyleneated fatty acid esters, primary alkanolamides, ethoxylated primary alkanolamides, secondary alkanolamides, ethoxylated secondary alkanolamides, tertiary acetylenic glycols, polyoxyethyleneated silicones, N-alkylpyrrolidones, alkylpolyglycosides, alkylpolylsaccharides, EO-PO blockpolymers, polyhydroxy fatty acid amides, amine oxides and mixtures thereof.

Suitable amphoteric surfactants are selected from the group comprising alkyl glycinates, propionates, imidazolines, amphoalkylsulfonates sold as “Miranol” by Rhone Poulenc, N-alkylamninopropionic acids, N-alkyliminodipropionic acids, imidazoline carboxylates, N-alkylbetaines, amido propyl betaines, sarcosinates, cocoamphocarboxyglycinates, amine oxides, sulfobetaines, sultaines and mixtures thereof. Additional suitable amphoteric surfactants include cocoamphoglycinate, cocoamphocarboxyglycinate, lauramphocarboxyglycinate, cocoamphopropionate, lauramphopropionate, stearamphoglycinate, cocoamphocarboxypropionate, tallowamphopropionate, tallowamphoglycinate, oleoamphoglycinate, caproamphoglycinate, caprylamphopropionate, caprylamphocarboxyglycinate, cocoyl imidazoline, lauryl imidazoline, stearyl imidazoline, behenyl imidazoline, behenylhydroxyethyl imidazoline, caprylamphopropylsulfonate, cocamphopropylsulfonate, stearamphopropylsolfonate, oleoamphopropylsulfonate and the like.

Other surfactants suitable for use in the invention include, but are not limited to, polyether siloxanes or alkoxylated polysiloxanes such as Niax L-5440 (available from OSI Specialties, Crompton), Tegostab B-8404 (available from Goldschmidt), Dabco DC-5357 (available from Air Products), and mixtures thereof.

Surface-active additives and foam stabilizers, may also be used in the invention. Suitable materials include, for example, the sodium salts of ricinoleic sulphonates, or salts of fatty acids and amines, such as oleic acid diethylamine or stearic acid diethanolamine. Alkali metal or ammonium salts of sulphonic acids, such as dodecyl benzene sulphonic acid or dinaphthylmethane, disulphonic acid or of fatty acids, such as ricinoleic acid, or of polymeric fatty acids may also be used as surface-active additives.

The foam stabilizers used are preferably polyether siloxanes, especially those which are water-soluble. These compounds generally have a polydimethyl siloxane group attached to a copolymer of ethylene oxide and propylene oxide. Foam stabilizers of this type have been described, for example, in U.S. Pat. Nos. 2,834,748; 2,917,480 and 3,629,308.

According to the invention, it is also possible to use known cell regulators such as paraffins or fatty alcohols or dimethyl polysiloxanes, as well as pigments or dyes and known flame-proofing agents, for example, trischloroethylphosphate, tricresylphosphate or ammonium phosphate or polyphosphate, also stabilizers against ageing and weathering, plasticizers, fungistatic and bacteriostatic substances and fillers, such as barium sulphate, kieslguhr, carbon black or whiting.

Other examples of surface-active additives, foam stabilizers, cell regulators, reaction retarders, stabilizers, flame-proofing substances, plasticizers, dyes, fillers and fungistatic and bacteriostatic substances which may also be used according to the invention and details concerning the use and action of these additives may be found in Kunststoff-Handbuch, Volume VII, published by Vieweg and Hochtlen, Carl-Hanser-Verlag, Munich 1966, for example on pages 103 and 113.

### Emulsifiers

The polyol blends may optionally include emulsifiers to prolong the stability and shelf-life of the dispersed polyol blends. Examples of suitable emulsifiers include sodium N-(2-hydroxy-5-nonylphenyl)methyl sarcosinate and soybean oil.

All documents, e.g., patents and journal articles, cited above or below are hereby incorporated by reference in their entirety.

One skilled in the art will recognize that modifications may be made in the invention without deviating from the spirit or scope of the invention. The invention is illustrated further by the following examples which are not to be construed as limiting the invention or scope of the specific procedures described herein.

The following is a description of certain materials used in the following examples:

Stepanpol PS-2352: a low functional (functionality of 2) modified diethylene glycol phthalate polyester polyol having an OH value of about 220-250, sold by Stepan Company, Northfield, Ill.

Stepanpol PS-3152: a low functional (functionality of 2) diethylene glycol phthalate polyester polyol having an OH value of about 290-325, sold by Stepan Company, Northfield, Ill.

Stepanpol®PS-2502-A: a low functional (functionality of 2) modified diethylene glycol phthalate polyester polyol having an OH value of about 230-250, sold by Stepan Company, Northfield, Ill.

Dabco®DC5357: a polysiloxane surfactant composed of dimethyl, methyl (polyethylene oxide) siloxane copolymer, sold by Air Products Corporation of Allentown, Pa.

Tegostab B8404: a polysiloxane surfactant composed of dimethyl, methyl (polyethylene oxide) siloxane copolymer, sold by Godlschmidt.

Niax®A-1: a catalyst which contains about 70% bis(2-dimethylaminoethyl) ether in 30% dipropylene glycol, sold by OSI Specialty Chemical.

Mondur MR®: polymethylene polyphenyl isocyanate having an isocyanate content of about 31.5%, commercially available from Bayer, Pittsburgh, Pa.

Thanol R-360: an alkoxylated sucrose glycerin polyether polyol having an OH value of about 345-375, sold by Eastman.

Polycat 8: Dimethylcyclohexylamine catalyst, sold by Air Products.

Jeffcat ZR-70: a catalyst containing 2-(2-(dimethylamino) ethoxy]ethanol, sold by Huntsman.

Pluracol P-975: a high functional alkoxylated sucrose diol having an OH value of approximately 380-420, sold by BASF.

Voranol-270: a low functional alkoxylated glycerin having an OH value of 230-250, sold by Dow Chemical.

Voranol-470X: an Mannich type polyol having an OH value of 460-480, sold by Dow Chemical.

Markol RB 216: an Mannich type polyol having an OH value of 470-490, sold by Quimica Pumex.

Silpol SIP-425LV: an Mannich type polyol having an OH value of 415-435, sold by Siltech Corp.

Carbowax 400: polyethylene glycol of approximately 400 MW sold by Union Carbide.

Makon 10: nonyl phenol ethoxylated with an average of 10 ethylene oxide units sold by Stepan Company.

Terate-203: a diethylene glycol terephthalate polyester polyol having an OH value of 300-330, sold by Kosa.

Surfactant L-5440: an alkoxylated polysiloxane surfactant sold by Crompton OSI.

Curithane 52: an isocyanate polymerization catalyst available from Air Products.

### General Experimental

Amounts of components in the below examples are percentages by weight of the polyol (resin) blend unless indicated otherwise. The individual resin components are added and mixed until a stable homogeneous polyol dispersion is obtained.

The polyol blends set forth below are prepared according to the invention and reacted by hand mixing and/or spraying with a polyisocyanate (Mondur MR®). The hand mixed foams are reacted in an amount of 150 g of total material at an isocyanate/resin weight ratio of 52/48 (approximately 1:1 isocyanate/resin ratio by volume). Unless otherwise indicated, the isocyanate and resin components are conditioned to 77 deg. F prior to mixing. The isocyanate is pre-weighted in a 32 ounce No. 2 cup. The desired quantity of resin component is then added to the isocyanate and the two are mixed vigorously for 3 seconds using a double Conn mix blade rotating at approximately 3500 rpm. The foam is allowed to rise and cure in the cup used for mixing. The properties of the hand mix foams are indicated below. Machine sprayed foams utilize either a Gusmer machine or GlasCraft machine with parameters as indicated by the particular examples.

EXAMPLE 1

| | |
|---|---|
| Phthalate Polyester (Stepanpol PS-3152) | 37.26% |
| Terate Polyester (Terate-203) | 14.90% |
| Propoxylated Glycerine (Voranol-270) | 22.35% |
| Surfactant (L-5440) | 1.49% |
| Cell Opener (Calcium Stearate) | 0.33% |
| Amine-Catalysts* | 5.23% |
| Lead Catalyst (30% Pb Naphthanate) | 0.22% |
| 2-Ethylhexanoic Acid | 0.37% |
| Diluents** | 14.90% |
| Water | 2.94% |

*Amine catalysts: Polycat 8 = 2.24%; Dimethylethanolamine = 2.24%; Curithane 52 = 0.75%.
**Diluents: tris-isopropylchlorophosphate.

| Hand Mix Properties | |
|---|---|
| Mix Ratio (A/B by Volume) | 1:1 |
| Component Temperatures | 77° F. |
| Initiation Time | 4 sec. |
| Tack Free Time | 11 sec. |
| Cup Density | 2.49 pcf |
| Resin Viscosity (77° F.) | 580 cps |

Machine Sprayed Properties (Gusmer H-2; GX-7 Gun; 120° F. Temps.; 800 psi Pressures)

Dim. Stability (100° F./95% R. H., 28 day, ASTM D-2126)-0.82%

Water Absorption (28 day weight gain) 1.75%

Water Vapor Permeability (with surface skin, ASTM E-96) 2.69 perm in. (permeability X inch)

Water Vapor Permeability (without surface skin, ASTM E-96) 4.59 perm in.

### EXAMPLE 2

EXAMPLE 2

| | |
|---|---|
| Phthalate Polyester (Stepanpol PS-3152) | 37.02% |
| Terate Polyester (Terate-203) | 14.81% |
| Propoxylated Glycerine (Voranol-270) | 22.21% |
| Surfactant (L-5440) | 2.04% |
| Cell Opener (Calcium Stearate) | 0.30% |
| Amine Catalysts* | 5.18% |
| Lead Catalyst (30% Pb Naphthanate) | 0.22% |
| 2-Ethylhexanoic Acid | 0.37% |
| Diluents** | 14.81% |
| Water | 3.04% |

*Amine catalysts: Polycat 8 = 2.22%; Dimethylethanolamine = 2.22%; Curithane 52 = 0.74%.
**Diluents: tris-isopropylchlorophosphate.

| Hand Mix Properties | |
|---|---|
| Mix Ratio (A/B by Volume) | 1:1 |
| Component Temperatures | 77° F. |
| Initiation Time | 5 sec. |
| Tack Free Time | 12 sec. |
| Cup Density | 2.53 pcf |
| Resin Viscosity (77° F.) | 550 cps |

Machine Sprayed Properties (Gusmer H-2; GX-7 Gun; 120° F. Temps.; 800 psi Pressures)

| Density (with passline, ASTM D-1622) | 2.76 pcf |
|---|---|
| Density (no passline, ASTM D-1622) | 2.19 pcf |
| Compressive Strength (with passline, ASTM D-1621) | 26.9 psi |
| Compressive Strength (no passline, ASTM D-1621) | 22.8 psi |
| Shear Strength (with passline, ASTM C-273) | 30.2 psi |
| Shear Strength (no passline, ASTM C-273) | 26.6 psi |
| Tensile Strength (with passline, ASTM D-1623) | 38.8 psi |
| Tensile Strength (no passline, ASTM D-1623) | 54.6 psi |
| Friability (with passline, % wt. loss, ASTM C-421) | 0.21% |
| Friability (no passline, % wt. loss, ASTM C-421) | 0.45% |
| Dim. Stab. (with passline, −20° F., 28 day, ASTM D-2126) | −0.01% |
| Dim. Stab. (with passline, 158° F., 28 day, ASTM D-2126) | −0.36% |
| Dim. Stab. (w/passline, 100° F./95% R.H., ASTM D-2126) | 0.91% |

### EXAMPLE 3

| | |
|---|---|
| Phthalate Polyester (Stepanpol PS-3152) | 46.11% |
| Propoxylated Sucrose (Pluracol P-975) | 23.05% |
| Surfactant (L-5440) | 2.11% |
| Cell Opener (Calcium Stearate) | 0.21% |
| Amine Catalysts* | 5.77% |
| Lead Catalyst (30% Pb Naphthanate) | 0.15% |
| 2-Ethylhexanoic Acid | 0.38% |
| Diluents** | 19.21% |
| Water | 3.01% |

*Amine catalysts: Polycat 8 = 2.50%; Dimethylethanolamine = 2.50%; Curithane 52 = 0.77%.
**Diluents: tris-isopropylchlorophosphate = 11.53%; Makon 10 = 7.68%.

| Hand Mix Properties | |
|---|---|
| Mix Ratio (A/B by Volume) | 1:1 |
| Component Temperatures | 77° F. |
| Initiation Time | 5 sec. |
| Tack Free Time | 12 sec. |
| Cup Density | 2.56 pcf |
| Resin Viscosity (77° F.) | 680 cps |

Machine Sprayed Properties (Gusmer H-2; GX-7 Gun; 120° F. Temps.; 800 psi Pressures)

| | |
|---|---|
| Density (with passline, ASTM D-1622) | 2.64 pcf |
| Density (no passline, ASTM D-1622) | 2.25 pcf |
| Compressive Strength (with passline, ASTM D-1621) | 30.3 psi |
| Compressive Strength (no passline, ASTM D-1621) | 17.2 psi |
| Shear Strength (with passline, ASTM C-273) | 22.3 psi |
| Shear Strength (no passline, ASTM C-273) | 20.8 psi |
| Tensile Strength (with passline, ASTM D-1623) | 42.7 psi |
| Tensile Strength (no passline, ASTM D-1623) | 36.6 psi |

### EXAMPLE 4

| | |
|---|---|
| Phthalate Polyester (Stepanpol PS-3152) | 45.27% |
| Mannich Polyol (Voranol 470X) | 20.89% |
| Diethylene Glycol | 3.48% |
| Surfactant (L-5440) | 2.09% |
| Cell Opener (Calcium Stearate) | 0.35% |
| Amine Catalysts* | 3.55% |
| Diluents** | 21.58% |
| Water | 2.79% |

*Amine catalysts: Polycat 8 = 1.25%; Dimethylethanolamine = 1.95%; Curithane 52 = 0.35%.
**Diluents: tris-isopropylchlorophosphate = 14.62%; Makon 10 = 6.96%.

| Hand Mix Properties | |
|---|---|
| Mix Ratio (A/B by Volume) | 1:1 |
| Component Temperatures | 77° F. |
| Initiation Time | 6 sec. |
| Tack Free Time | 13 sec. |
| Cup Density | 2.81 pcf |
| Resin Viscosity (77° F.) | 600 cps |

Machine Sprayed Properties (Gusmer H-2; GX-7 Gun; 120° F. Temps.; 800 psi Pressures)

| Shear Strength (with passline, ASTM C-273) | 32.7 psi |
|---|---|
| Shear Strength (no passline, ASTM C-273) | 46.6 psi |
| Tensile Strength (with passline, ASTM D-1623) | 64.7 psi |
| Tensile Strength (no passline, ASTM D-1623) | 99.2 psi |
| Friability (with passline, % wt. loss, ASTM C-421) | 0.61% |
| Friability (no passline, % wt. loss, ASTM C-421) | 1.35% |
| Dim. Stab. (with passline, −20° F., 28 day, ASTM D-2126) | 0.20% |
| Dim. Stab. (no passline, −20° F., 28 day, ASTM D-2126) | 0.20% |
| Dim. Stab. (with passline, 158° F., 28 day, ASTM D-2126) | 1.12% |
| Dim. Stab. (no passline, 158° F., 28 day, ASTM D-2126) | −0.91% |
| Dim. Stab. (w/passline, 100° F./95% R.H., ASTM D-2126) | 3.37% |
| Dim. Stab. (no passline, 100° F./95% R.H., ASTM D-2126) | −0.05% |
| Dim. Stab. (w/passline, 158° F./95% R.H., ASTM D-2126) | 0.45% |
| Dim. Stab. (no passline, 158° F./95% R.H., ASTM D-2126) | −2.60% |
| Water Absorption (Gusmer H-2, GX-7, 800 psi, D-2842) | 2.56% |
| Water Absorption (Gus. H-2000, GX-7, 1500 psi, D-2842) | 0.08% |

### EXAMPLE 5

| | |
|---|---|
| Phthalate Polyester (Stepanpol PS-3152) | 36.93% |
| Mannich Polyol (Voranol 470X) | 26.87% |
| Diethylene Glycol | 6.72% |
| Surfactant (L-5440) | 2.02% |
| Cell Opener (Calcium Stearate) | 0.32% |
| Amine Catalysts* | 3.77% |
| Diluents** | 20.83% |
| Water | 2.54% |

*Amine catalysts: Polycat 8 = 1.21%; Dimethylethanolamine = 1.88%; Curithane 52 = 0.34%; Niax A-1 = 0.34%.
**Diluents: tris-isopropylchlorophosphate = 14.11%; Makon 10 = 6.72%.

### Hand Mix Properties

| | |
|---|---|
| Mix Ratio (A/B by Volume) | 1:1 |
| Component Temperatures | 77° F. |
| Initiation Time | 5 sec. |
| Tack Free Time | 12 sec. |
| Cup Density | 2.94 pcf |
| Resin Viscosity (77° F.) | 550 cps |

Machine Sprayed Properties (Gusmer H-2; GX-7 Gun; 120° F. Temps.; 800 psi Pressures)

| | |
|---|---|
| Density (with passline, ASTM D-1622) | 2.74 pcf |
| Compressive Strength (with passline, ASTM D-1621) | 34.7 psi |
| Shear Strength (with passline, ASTM C-273) | 38.1 psi |
| Tensile Strength (with passline, ASTM D-1623) | 65.6 psi |
| Friability (with passline, % wt. loss, ASTM C-421) | 0.33% |
| Dim. Stab. (with passline, −20° F., | −0.44% |
| 28 day, ASTM D-2126) | |
| Dim. Stab. (with passline, 158° F., | −1.49% |
| 28 day, ASTM D-2126) | |
| Dim. Stab. (w/passline, 158° F./95% | −3.13% |
| R.H., ASTM D-2126) | |
| Water Vapor Permeability (with passline, ASTM E-96) | 2.01 perm in. |

Machine Sprayed Prop. (Gusmer H-2000; GX-7 Gun; 130° F. Temps.; 1500 psi Pressures)

| | |
|---|---|
| Density (with passline, ASTM D-1622) | 3.18 pcf |
| Density (no passline, ASTM D-1622) | 2.93 pcf |
| Compressive Strength (with passline, | 41.3 psi |
| ASTM D-1621) | |
| Compressive Strength (no passline, | 40.0 psi |
| ASTM D-1621) | |
| Water Vapor Permeability (with passline, | 1.23 perm in. |
| ASTM E-96) | |

### EXAMPLE 6

| | |
|---|---|
| Phthalate Polyester (Stepanpol PS-3152) | 42.54% |
| Mannich Polyol (Markol RB 216) | 15.47% |
| Diethylene Glycol | 5.80% |
| Surfactant (L-5440) | 1.90% |
| Cell Opener (Calcium Stearate) | 0.48% |
| Amine Catalysts* | 3.46% |
| Diluents** | 27.85% |
| Water | 2.49% |

*Amine catalysts: Polycat 8 = 1.06%; Dimethylethanolamine = 1.66%; Curithane 52 = 0.39%; Niax A-1 = 0.35%.
**Diluents: tris-isopropylchlorophosphate = 16.25%; Makon 10 = 11.60%.

### Hand Mix Properties

| | |
|---|---|
| Mix Ratio (A/B by Volume) | 1:1 |
| Component Temperatures | 77° F. |
| Initiation Time | 5 sec. |
| Tack Free Time | 11 sec. |
| Cup Density | 2.99 pcf |
| Resin Viscosity (77° F.) | 520 cps |

Machine Sprayed Properties (Gusmer H-2; GX-7 Gun; 120° F. Temps.; 800 psi Pressures)

| Density (with passline, ASTM D-1622) | 3.82 pcf |
|---|---|
| Density (no passline, ASTM D-1622) | 3.22 pcf |
| Compressive Strength (with passline, ASTM D-1621) | 61.8 psi |
| Compressive Strength (no passline, ASTM D-1621) | 52.1 psi |
| Shear Strength (with passline, ASTM C-273) | 42.4 psi |
| Shear Strength (no passline, ASTM C-273) | 52.3 psi |
| Tensile Strength (with passline, ASTM D-1623) | 68.9 psi |
| Tensile Strength (no passline, ASTM D-1623) | 72.8 psi |
| Friability (with passline, % wt. loss, ASTM C-421) | 0.31% |
| Friability (no passline, % wt. loss, ASTM C-421) | 0.34% |
| Water Absorption (no passline, ASTM D-2842) | 0.58% |

### EXAMPLE 7

| | |
|---|---|
| Phthalate Polyester (Stepanpol PS-3152) | 32.47% |
| Mannich Polyol (Silpol SIP-425LV) | 21.65% |
| Diethylene Glycol | 7.22% |
| Surfactant (L-5440) | 1.77% |
| Cell Opener (Calcium Stearate) | 0.39% |
| Amine Catalysts* | 3.36% |
| Diluents** | 30.97% |
| Water | 2.16% |

*Amine catalysts: Polycat 8 = 1.04%; Dimethylethanolamine = 1.63%; Curithane 52 = 0.36%; Niax A-1 = 0.33%.
**Diluents: tris-isopropylchlorophosphate = 15.15%; Makon 10 = 10.82%; Propylene Carbonate = 5.00%.

### Hand Mix Properties

| | |
|---|---|
| Mix Ratio (A/B by Volume) | 1:1 |
| Component Temperatures | 77° F. |
| Initiation Time | 5 sec. |
| Tack Free Time | 13 sec. |
| Cup Density | 3.08 pcf |
| Resin Viscosity (77° F.) | 320 cps |

Machine Sprayed Properties (GlasCraft; Probler Gun; 120° F. Temps.; 1500 psi Pressures)

| Density (with passline, ASTM D-1622) | 3.14 pcf |
|---|---|
| Compressive Strength (with passline, ASTM D-1621) | 43.0 psi |
| Shear Strength (with passline, ASTM C-273) | 46.8 psi |
| Tensile Strength (with passline, ASTM D-1623) | 76.4 psi |
| Friability (with passline, % wt. loss, ASTM C-421) | 0.71% |
| Dim. Stab. (with passline, 158° F., | 0.58% |
| 28 day, ASTM D-2126) | |
| Dim. Stab. (w/passline, 100° F./95% | −0.32% |
| R.H., ASTM D-2126) | |
| Dim. Stab. (w/passline, 158° F./95% R.H., | −2.44% |
| ASTM D-2126) | |
| Water Vapor Permeability (with passline, ASTM E-96) | 2.09 perm in. |
| Water Absorption (no passline, ASTM D-2842) | 0.79% |

Machine Sprayed Prop. (Gusmer H-2000; GX-7 Gun; 130° F. Temps.; 1500 psi Pressures)

| | |
|---|---|
| Density (with passline, ASTM D-1622) | 3.18 pcf |
| Compressive Strength (with passline, ASTM D-1621) | 41.9 psi |

### EXAMPLE 8

| | |
|---|---|
| Polyethylene Glycol (Carbowax 400) | 32.70% |
| Mannich Polyol (Silpol SIP-425LV) | 21.80% |
| Diethylene Glycol | 7.27% |
| Surfactant (L-5440) | 0.75% |
| Cell Opener (Calcium Stearate) | 0.40% |
| Amine Catalysts* | 3.36% |
| Diluents** | 31.17% |
| Water | 2.55% |

*Amine catalysts: Polycat 8 = 1.04%; Dimethylethanolamine = 1.63%; Curithane 52 = 0.36%; Niax A-1 = 0.33%.
**Diluents: tris-isopropylchlorophosphate = 15.26%; Makon 10 = 10.90%; Dibasic Esters = 5.00%.

### Hand Mix Properties

| | |
|---|---|
| Mix Ratio (A/B by Volume) | 1:1 |
| Component Temperatures | 77° F. |
| Initiation Time | 4 sec. |
| Tack Free Time | 12 sec. |
| Cup Density | 2.97 pcf |
| Resin Viscosity (77° F.) | 130 cps |
| Cup Open Cell Content | 95.7% |
| Hand Mix Dimensional Stability | <2.0% |
| (158° F./95% R.H., 7 Days) | |

### EXAMPLE 9

| | |
|---|---|
| Polyethylene Glycol (Carbowax 400) | 39.79% |
| Mannich Polyol (Silpol SIP-425LV) | 26.53% |
| Surfactant (L-5440) | 0.75% |
| Cell Opener (Calcium Stearate) | 0.40% |
| Amine Catalysts* | 3.36% |
| Diluents** | 26.62% |
| Water | 2.55% |

*Amine catalysts: Polycat 8 = 1.04%; Dimethylethanolamine = 1.63%; Curithane 52 = 0.36%; Niax A-1 = 0.33%.
**Diluents: tris-isopropylchlorophosphate = 15.56%; Makon 10 = 11.05%.

### Hand Mix Properties

| | |
|---|---|
| Mix Ratio (A/B by Volume) | 1:1 (by volume) |
| Component Temperatures | 77° F. |
| Initiation Time | 4 sec. |
| Tack Free Time | 12 sec. |
| Cup Density | 3.02 pcf |
| Resin Viscosity (77° F.) | 180 cps |
| Cup Open Cell Content | 92.4% |
| Hand Mix Dimensional Stability | <2.0% |
| (158° F./95% R.H., 7 Days) | |

The invention and the manner and process of making and using it, are now described in such full, clear, concise and exact terms as to enable any person skilled in the art to which it pertains, to make and use the same. It is to be understood that the foregoing describes preferred embodiments of the present invention and that modifications may be made therein without departing from the spirit or scope of the present invention as set forth in the claims. To particularly point out and distinctly claim the subject matter regarded as invention, the following claims conclude this specification.

What is claimed:

1. A method for preparing a polymeric foam comprising urethane units and having an open-cell content sufficient to resist shrinkage, the method comprising reacting an aromatic polymeric isocyanate with a polyol blend at an NCO/OH index of from about 85-125, where the polyol blend comprises: (a) from about 20% to about 90% by weight of the blend of a polyol formulation comprising a polyester polyol, a polyether polyol, a Mannich-type polyol, or mixtures thereof; (b) a blowing agent; (c) a cell opening agent which is a divalent metal salt of a fatty acid; and (d) from about 0.05% to about 50% by weight of the blend of a diluent or mixture of diluents.

2. The method of claim 1, wherein the polyol formulation comprises from about 25%-75% by weight of a polyester polyol or a mixture of polyester polyols.

3. The method of claim 1, wherein the polyester polyol has an OH value of from about 150 to about 350 and a molecular weight of from about 350 to 700.

4. The method of claim 1, wherein the polyol blend comprises from about 0.05%-3% by weight of the blend of a cell opening agent.

5. The method of claim 1, wherein the polyol blend comprises from about 3.5-50% by weight of the blend of a diluent.

6. The method of claim 1, where the blend comprises from about 28-80% by weight of a polyester polyol.

7. The method of claim 6, wherein the diluent comprises tris-isopropylchlorophosphate, alkoxylated nonyl phenol, propylene carbonate, an alkyl ester of a monobasic acid, a dialkyl ester of a dibasic acid, or mixtures thereof.

8. The method of claim 7, wherein the polyol blend further comprises up to about 5% by weight of an acid based on the weight of the polyol blend.

9. The method of claim 7, wherein the polyol blend further comprises a surfactant.

10. The method of claim 7, wherein the polyol blend comprises from about 0.05%-1.5% by weight of the cell opening agent, based on the weight of the blend.

11. The method of claim 10, wherein the cell opening agent has a softening point of from about 100-180.degree. C.

12. The method of claim 11, wherein the aromatic polymeric isocyanate is a polymethylene polyphenyl isocyanate.

13. The method of claim 1, wherein the blowing agent comprises water.

14. The method of claim 1, wherein the polyol blend comprising the cell opening agent is a stable dispersion.

15. A polyurethane foam prepared according to the method of claim 1.

16. The polyurethane foam of claim 15, having an in-place density of from about 2.0 to 3.5 lbs./ft.sup.3.

17. The polyurethane foam of claim 15, wherein the foam comprises from about 0.01 to 1% by weight of a cell opening agent which is a divalent metal salt of a fatty acid, the foam having an open-cell content sufficient to resist shrinkage and exhibiting less than about 5% shrinkage when stored at about 158. degree. F. and about 100% relative humidity for about 28 days.

18. The polyurethane foam of claim 15, exhibiting less than about 3% shrinkage when stored at −20.degree. F. for 28 days.

19. The method of 3, wherein the acid is an alkanoic acid or an alkenoic acid.

20. The method of claim 1, wherein the polyol formulation comprises from about 1% to 100% by weight of a diethylene glycol phthalate polyester polyol having an OH value of from about 150 to 350 and comprising (a) the reaction product of a mixture comprising a phthalic acid compound and a low molecular weight aliphatic diol, and (b) an optional nonionic surfactant, and where the diethylene glycol phthalate polyester polyol has a molecular weight of from about 350 to 700.

21. The method of claim 20, further comprising up to about 5% by weight of an alkanoic or alkenoic acid based on the weight of the polyol blend.

22. The method of claim 21, wherein the alkanoic or alkenoic acid has the formula RCO.sub.2H, where R is hydrogen, a straight or branched chain alkyl group having from about 1 to 12 carbon atoms, or a straight or branched chain alkenyl group having from about 2 to 12 carbon atoms.

23. A reaction mixture comprising the polyol blend of claim 22 and a polyisocyanate.

24. The reaction mixture of claim 23, wherein the polyol blend and polyisocyanate are present in the mixture at a volume ratio of about 1:1.

25. A spray foam generated by the reaction product of claim 23.

26. The spray foam of claim 25, where the foam comprises open celled foam.

27. The spray foam of claim 26, where the foam has a sprayed in-place density of from about 2.0 to 3.5 pcf.
